(19) United States
(12) Patent Application Publication
(10) Pub. No.: US 2003/0121677 A1
(43) Pub. Date: Jul. 3, 2003

(54) Work control system

(75) Inventors: Masahiro Watanabe, Anjo-shi (JP); Goushi Ishikawa, Anjo-shi (JP)

Correspondence Address: ORRICK, HERRINGTON & SUTCLIFFE, LLP, 4 PARK PLAZA, SUITE 1600, IRVINE, CA, 92614-2558, US

(73) Assignee: Makita Corporation, Inc.

(21) Appl. No.: 10/328,926

(22) Filed: Dec. 23, 2002

(30) Foreign Application Priority Data
Dec. 23, 2001 (JP) 2001-403123

(51) Int. Cl. B25D 1/00

(52) U.S. Cl. 173/2; 173/176

(57) ABSTRACT

It is an object of the invention to provide work control system that can prevent an interference of the transmitting signals of the power tools in relation to the work progress. A representative work control system according to the present teachings may include a plurality of power tools and detecting device. Each of the power tools may transmit signals relating to the work progress. The detecting device may detect the work progress of each of the power tools by receiving and detecting the signals transmitted from the respective power tools. The signals relating to the work progress may be transmitted from each power tool several times. Preferably, the transmission intervals may vary among the power tools in order to prevent the signals from being confused.

### BACKGROUND OF THE INVENTION

1. Field of the Invention

The present invention relates to work control system to control work progress of a plurality of power tools, e.g., such as a management of the number of screws to be tightened in screw tightening operation by means of a plurality of impact drivers.

2. Description of the Related Art

Japanese Laid-Open Patent Publication No. 6-312381 discloses a work control system for controlling work progress by receiving signals relating to the work progress generated by and transmitted from the respective power tools. The known work control system receives the signals to control specific operation of power tools. When this work control system is applied to an operation using a plurality of power tools, one power tool transmits a work control signal, while another power tool also transmits a work control signal. In such a case, the receiver of the work controller may possibly receive the work control signals from the both power tools at the same time. If the receiver receives the both signals at the same time, the both signals may interfere with each other and the work controller may be in difficulty to properly determine the work progress of each of the power tools.

### SUMMARY OF THE INVENTION

It is, accordingly, an object of the present teachings to provide work control system that can prevent an interference of the transmitting signals of the power tools in relation to the work progress.

A work control system according to the present teachings may include a plurality of power tools and detecting device. Each of the power tools may transmit signals relating to the work progress. The detecting device may detect the work progress of each of the power tools by receiving and detecting the signals transmitted from the respective power tools. The signals relating to the work progress may be transmitted from each power tool several times. Preferably, the transmission intervals may vary among the power tools in order to prevent the signals from being confused.

Other objects, features and advantages of the present invention will be readily understood after reading the following detailed description together with the accompanying drawings and the claims.

### BRIEF DESCRIPTION OF THE DRAWINGS

FIG. 1 is a diagram showing a work control system according to the representative embodiment of the present teachings.

FIG. 2 is a partly broken-apart side view of an impact driver used within the work control system of the representative embodiment.

FIG. 3 is a system block diagram showing the impact driver used within the work control system of the representative embodiment.

FIG. 4 is a system block diagram showing a work control mechanism that is used in the work control system of the embodiment.

FIG. 5 is a flow chart showing a procedure to transmit a tightening completion signal within the impact driver.

FIG. 6 is a flow chart showing a procedure of the work control device that receives the tightening completion signal.

FIG. 7 shows transmission of tightening completion signals generated within the power tool A of the representative embodiment.

FIG. 8 shows transmission of tightening completion signals generated within the power tool B of the representative embodiment.

FIG. 9 shows transmission of tightening completion signals generated within the power tool C of the representative embodiment.

FIG. 10 shows an example of transmission of tightening completion signals generated within the power tool A.

FIG. 11 shows an example of transmission of tightening completion signals generated within the power tool B.

FIG. 12 shows an example of transmission of tightening completion signals generated within the power tool C.

### DETAILED DESCRIPTION OF THE INVENTION

According to one aspect of the present teachings, a representative work control system to utilize power tools may be constructed. The system may include a plurality of power tools and a detecting device. The detecting device may receive signals in relation to work progress of the power tools. The signals may be transmitted from the respective power tools so that the detecting device may detect the work progress of each power tool. Each power tool may transmit signals several times and transmission intervals of the signals vary among the power tools. In other words, the time intervals in transmitting signals are different in relation to the respective power tools.

As a result, even if the detecting device receives signals relating to the work progress from power tools at the same time, the signals are subsequently transmitted from each power tool at the intervals that vary among the power tools. In other words, even if the detecting device receives the first signals from the plurality of power tools at the same time and even if any interference may be caused among the signals due to such receipt of the signals at the same time, the second signals can be transmitted from each power tool at different timing because the transmission intervals of the signals vary among the power tools. Thus, it is made possible to positively identify and control the work progress of each of the power tools without causing interference due to simultaneous reception of the signals.

The “plurality of power tools” may include a plurality of power tools of different kinds as well as of the same kind. The “power tools” may include various tools, whether portable or fixed, or whether battery-type or not, such as drills, drivers, wrenches and saws. Further, the “signals relating to the work progress” may include information regarding the various works performed by the power tool. For example, work completion information of whether the associated power tool has completed a specific operation or not, information of the number of screws that have been tightened, and information of the value of torque to tighten the screw may preferably define the signals relating to the work progress. As for “transmitting a signal relating to the work progress several times at intervals that vary among the power tools”, the transmission intervals of the signals may be set in advance at values that vary among the power tools. Alternatively, the transmission intervals may be randomly selected at each time so that the transmission intervals vary among the power tools.

As another aspect of the present teachings, within the representative work control system, the work progress may preferably be identified by the combination of the plurality of signals. That means that each of the signals may define information regarding the work progress when each signal is combined together. In such case, the plurality of signals may preferably be transmitted at time intervals that are set at values varying among the power tools. As a result, the signals transmitted from respective power tools may be prevented from being detected by the detecting device at the same time and thus, interference between the signals can be avoided.

Each of the additional features and method steps disclosed above and below may be utilized separately or in conjunction with other features and method steps to provide improved work control systems and method for controlling such work control system and devices utilized therein. Representative examples of the present invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings.

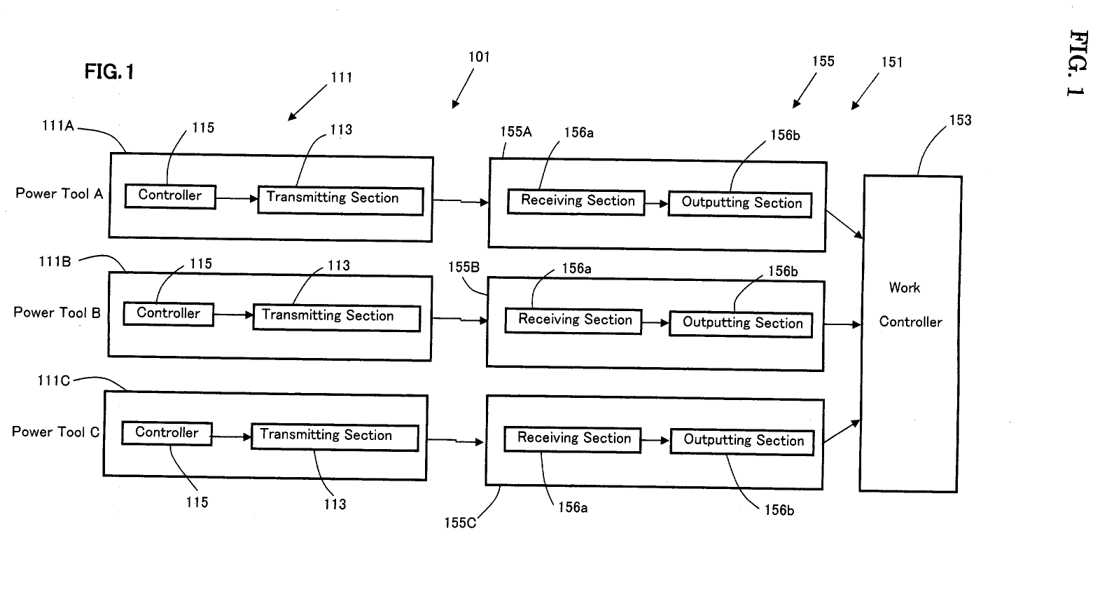

FIG. 1 is a diagram showing a work control system 101 according to a representative embodiment of the present invention. In general, the work control system 101 may have a group of power tools 111 including a plurality of power tools A, B, C (designated by 111A, 111B and 111C in FIG. 1), and a work control device 151. Each of the power tools A, B, C includes a controller 115 and a transmitting section 113. The work control device 151 includes receivers 155A, 155B and 155C and a work controller 153. The receivers 155A, 155B and 155C correspond to the respective transmitting sections 113 of the power tools 111A, 111B and 111C. Each of the receivers 155A, 155B and 155C has a receiving section 156a and an outputting section 156b. Each of the receivers 155A, 155B and 155C receives a screw tightening completion signal transmitted from each of the power tools 111A, 111B and 111C. Each of the receivers 155A, 155B and 155C detects and distinguishes as to whether the received screw tightening completion signals are corresponding to the signals that should be generated and transmitted from the associated one of the power tools 111A, 111B and 111C. When the receiver identifies the signal as one from the corresponding power tool, the receiver outputs work controller 153a detecting signal of tightening completion of the corresponding power tool 111A, 111B or 111C by means of the outputting section 156b. The receivers 155A, 155B and 155C are coupled to the work controller 153 via the respective outputting sections 156b. The work controller 153 performs work controlling based on the screw tightening completion signal outputted from the receivers 155A, 155B and 155C associated with the power tools 111A, 111B and 111C respectively. Within the representative embodiment, the signals may be transmitted in a wireless manner from the transmitting sections 113 of the power tools 111A, 111B and 111C to the receiving sections 156a of the respective receivers 155A, 155B and 155C. Otherwise, any other devices such as a cable, that connects the outputting sections 156b to the work controller 153, may preferably be utilized for outputting signals from the receivers 155A, 155B and 155C to the work controller 153. Receivers 155A, 155B and 155C (and/or the work control device 151) within the present embodiment may correspond to the features of “detecting device” according to the present teachings.

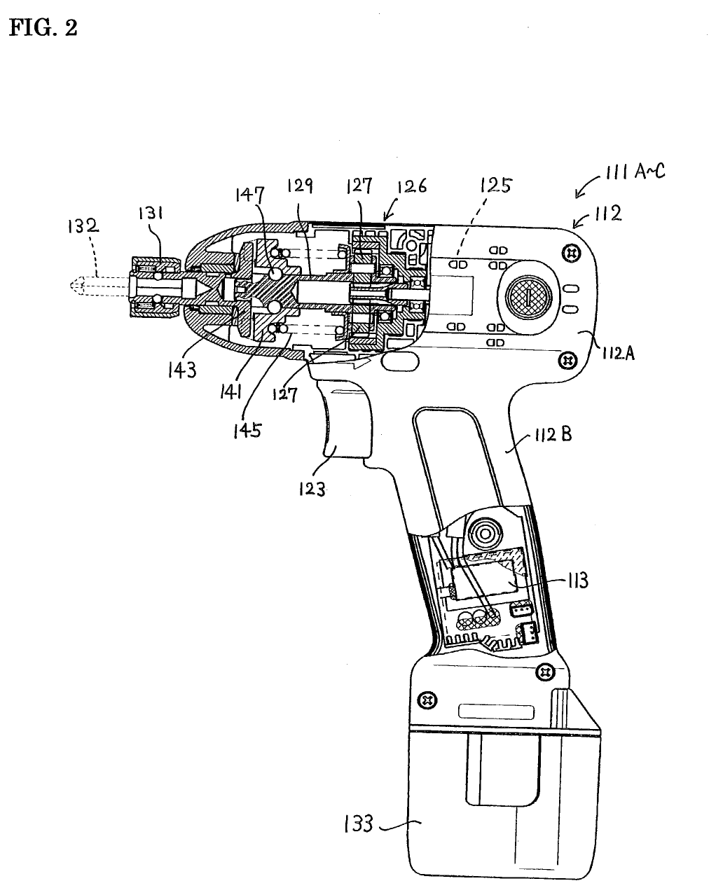

FIG. 2 shows one of the exemplary construction of the power tools 111A, 111B and 111C that pertain to the power tool group 111. A screw tightening impact driver 112 is used as any one of the power tools 111A, 111b and 111C. Inpact driver 112 includes a motor housing 112A and a hand grip 112B. A motor 125 (not directly shown), a speed reducing mechanism that mainly includes a planetary gear 127, a spindle 129, a hammer 141, an anvil 143 and a tool mounting chuck 131 are disposed within the motor housing 112A. A driver bit 132 is coupled to the tool mounting chuck 131. The hammer 141 can move relative to the spindle 129 in its axial direction and is biased toward the anvil 143 by means of a spring 145.

The rotational movement of the motor 125 is transmitted to the spindle 129 while being decelerated by the speed reducing mechanism 126. When the screw tightening operation is performed with lower torque by using the driver bit 132, the rotational movement of the spindle 129 is continuously transmitted to the hammer 141 and anvil 143, so that the screw tightening operation is continuously performed with the driver bit 132. While, when larger torque is applied in the screw tightening operation, the hammer 141 receives a larger force via balls 147 and thus moves backward against the force of the spring 145 and idly rotates. Thereafter, the hammer 141 collides with the anvil 143 by the biasing force of the spring 145 and thus generates high tightening torque.

A trigger switch 123 for starting the motor 125 is provided on the upper end portion of the hand grip 112B, and a battery 133 is detachably mounted onto the lower end portion of the grip 112B. The transmitting section 113, which will now be explained in more detail below, is disposed within the hand grip 112B.

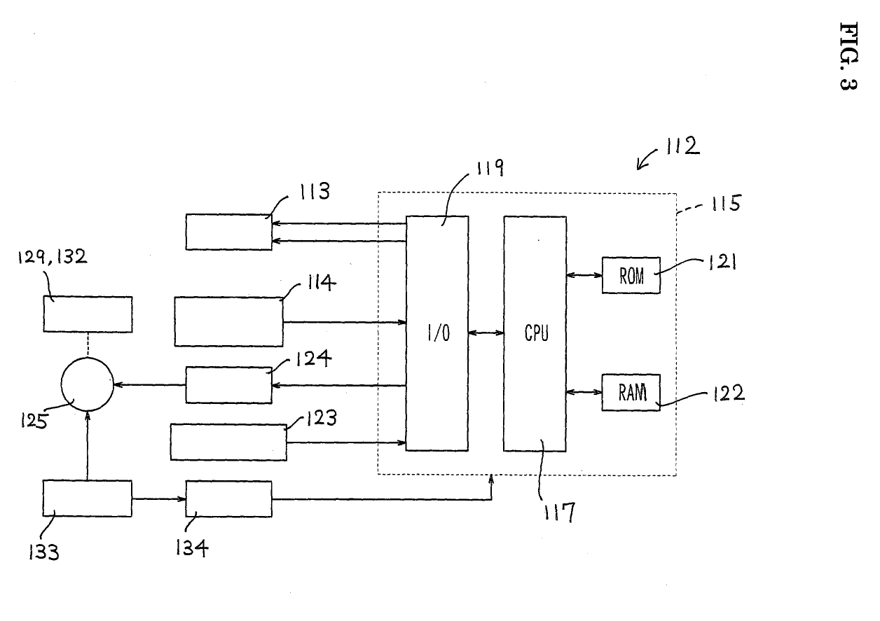

FIG. 3 shows a system block diagram of the impact driver 112. A controller (microcomputer) 115 may integrally include a CPU 117, a ROM 121, a RAM 122 and an I/O port 119. Controller 115 is powered by the battery 133 via a power circuit 134. Transmitting section 113, screw tightening completion detecting section 114, driving circuit 124 and trigger switch 123 are coupled to the controller 115. The motor 125 is connected to and controlled by the driving circuit 124 and drives output-shaft sided members comprising the spindle 129 and driver bit 132 by means of the battery 133. When user of the impact driver 112 operates the trigger switch 123, the controller 115 controls the motor 125 and output-shaft sided members (the spindle 129 and the driver bit 132) via the driving circuit 124. During the driving of the motor 125 via the driving circuit 124, the controller 115 receives detection signals outputted from the screw tightening completion detecting section 114. When completion of the screw tightening operation is detected by means of the detection signal of the screw tightening completion detecting section 114, the transmitting section 113 transmits a tightening completion signal, which will be explained in more detail below.

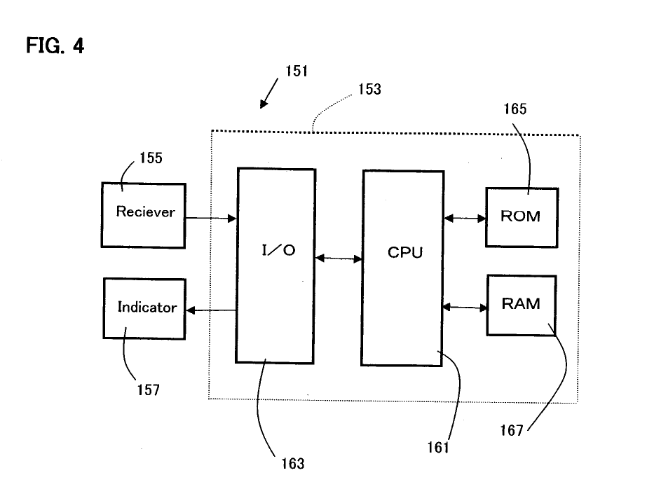

FIG. 4 is a system block diagram of the work control device 151 according to the representative embodiment. The work control device 151 comprises a work controller 153, a receiver 155 and an indicator 157. The work controller 153 includes CPU 161, ROM 165, RAM 167 and I/O port 163. The receiver 155 and the indicator 157 are connected to the work controller 153 via the I/O port 163.

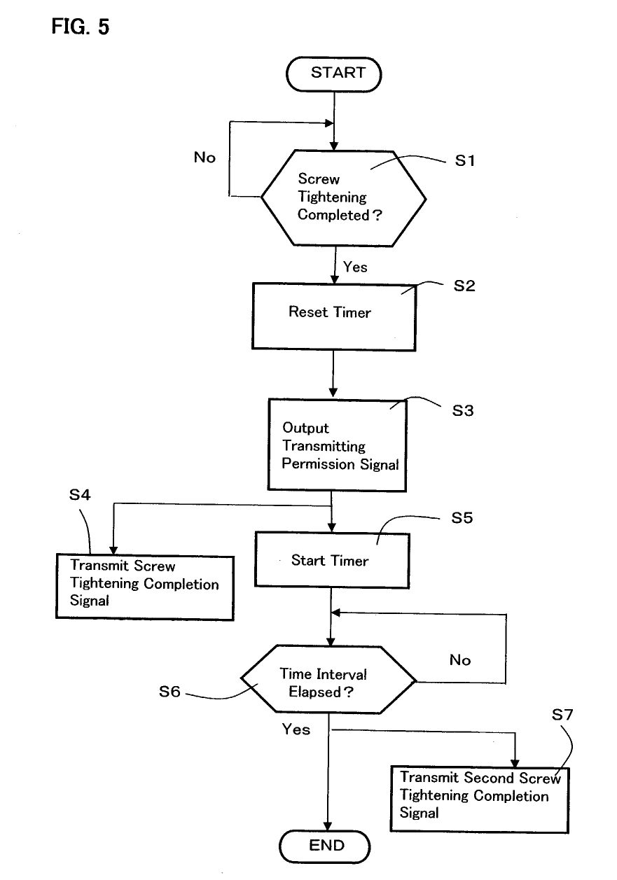

FIG. 5 is a flow chart showing procedure for completing a screw tightening operation by utilizing the impact driver 112 as shown in FIG. 2. This procedure is represented by a work controlling program and stored within the ROM 121 (see FIG. 3). The ROM 121 is provided in each of the power tools 111A, 111B and 111C. In step S1 of the procedure, it is determined as to whether the screw tightening operation has been completed. Specifically, it is determined by means of the screw tightening completion detecting section 114 (see FIG. 3) as to whether the torque applied onto the driver bit 132 shown in FIG. 2 has exceeded a predetermined reference range. When it is determined that the torque has exceeded the predetermined reference range, the screw tightening operation is determined to have been completed and thus, step S2 is executed. When the torque is determined as not exceed the predetermined reference range, step S1 will be repeated until it is determined that the torque has exceeded the predetermined reference range.

In step S2, a timer is reset in order to selectively determine the transmitting intervals in transmitting a screw tightening completion signal two or more times. Then in step S3, a transmitting permission signal is outputted to the transmitting section 113. In step S4, a screw tightening completion signal is transmitted from the transmitting section 113 based upon the transmitting permission signal outputted to the transmitting section 113. Further, in step S5, the timer starts based on the outputted transmitting permission signal. In step S6, it is determined whether a predetermined time interval has elapsed. This predetermined time interval corresponds to the time interval between the transmission of the first screw tightening completion signal and the transmission of the second screw tightening completion signal. In step S6, it is determined as to whether the predetermined time interval has elapsed since the timer was started in step S5 and the first screw tightening completion signal was transmitted. In other words, it is determined within step S6 as to when the second screw tightening completion signal should be transmitted after the first screw tightening completion signal is transmitted. Specifically, in step S6, it is determined as to whether the predetermined time interval has elapsed. When it is determined that the predetermined time interval has not elapsed yet (when it is determined as “No” in step S6), step S6 will be repeated until it is determined that the predetermined time interval has elapsed. When it is determined that the predetermined time interval has elapsed (when it is determined as “Yes” in step S6), as it is shown within step S7, the second screw tightening completion signal is transmitted. As the result the procedural steps will be completed.

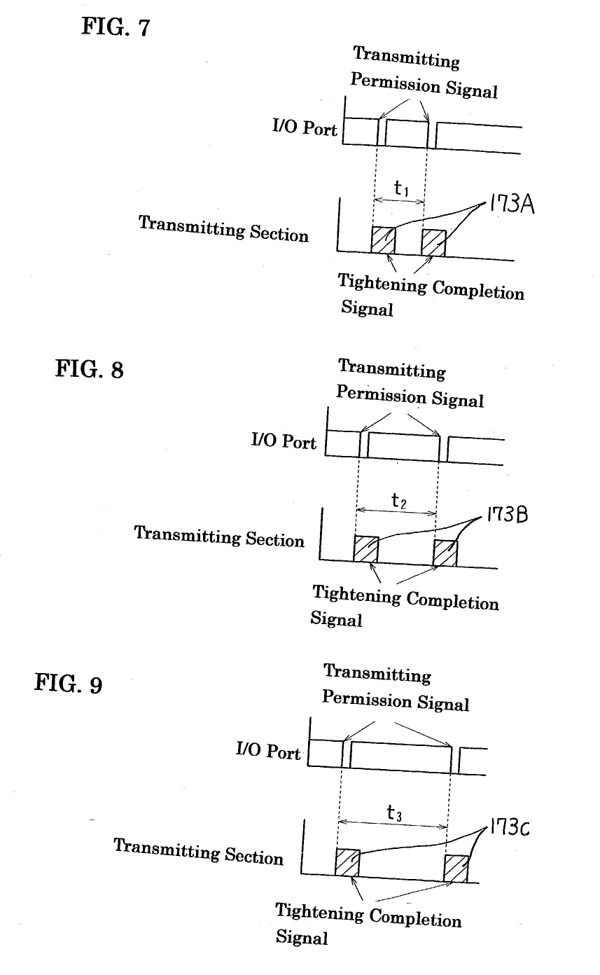

FIGS. 7, 8 and 9 show examples of screw tightening completion signals generated in the power tools 111A, 111B and 111C, respectively. The screw tightening completion signals will be explained with reference to FIG. 7 as a representative example. When the controller 115 shown in FIG. 3 outputs a transmitting permission signal to the transmitting section 113 via the I/O port 119, a tightening completion signal 173A is transmitted from the transmitting section 113 based upon the outputted transmitting permission signal. The transmitting section 113 may transmit the signal 173A in a wireless manner. In this representative embodiment, a NOT circuit (not particularly shown) is used as a logic circuit and by utilizing this circuit, it is determined that a transmitting permission signal has been outputted when the output value to the microcomputer output port is detected to be zero. As the result of such detection and determination, a tightening completion signal 173A is outputted. After a lapse of a predetermined time interval of t1 seconds since the first transmitting permission signal was outputted, the second transmitting permission signal is outputted. Based upon the second transmitting permission signal, the second screw tightening completion signal 173A is transmitted to the outside from the transmitting section 113 in a wireless manner Specifically, in the power tool 111A, the screw tightening completion signal 173A is transmitted twice at a transmission interval of t1 seconds.

Although it is not particularly illustrated in the drawings, each of the screw tightening completion signals (the first and the second screw tightening completion signals) may preferably include information for identifying the associated power tool and information for managing and controlling the work performed by the respective power tool such as the number of screws which have been tightened by the impact driver. The screw tightening completion signal may preferably be defined by 8 bits data. For example, the screw tightening completion signals may be represented by 8 bits data such as “10000010” (“#82H” in hexadecimal notation) for the power tool 111A and “01111101” (“#7DH” in hexadecimal notation) for the power tool 111B.

With respect to the power tools 111B and 111C as well, the screw tightening completion signals 173B and 173C as shown in FIGS. 8 and 9 are outputted to the transmitting section 113 in a similar manner to the signal 173A as shown in FIG. 7. According to the representative embodiment, the screw tightening completion signals 173B and 173C are adopted and arranged to be different from the signal 173A as shown in FIG. 7 with respect to the transmission intervals. While the signal 173A has a transmission interval of t1 seconds, the signal 173B and 173C may have different transmission intervals of t2 seconds and of t3 seconds, respectively. Specifically, in the power tools 111B and 111C, the screw tightening completion signals 173B and 173C are transmitted twice at a transmission interval of t2 seconds and of t3 seconds, respectively.

In this representative embodiment, the transmission intervals t1, t2, t3 in the power tools 111A, 111B, 111C are arranged to be “t1<t2 <t3”. In other others, the screw tightening completion signals 173A, 173B, 173C are designed to have transmission intervals different from each other. In this connection, when the first screw tightening completion signal is transmitted, any of the receivers 155A, 155B and 155C may possibly receive screw tightening completion signals for the respective power tools 111A, 111B and 111C at the same time. In such case, the signals received at the same time may possibly interfere with each other. However, according to the representative embodiment, because the timing of transmitting the second screw tightening completion signals 173A, 173B and 173C will respectively be transmitted at different intervals of t1, t2 and t3 seconds, respectively. Thus, respective receiver 155A, 155B and 155C will receive the second screw tightening completion signals at different timing. As a result, the tightening completion signals may not interfere with each other due to such different intervals in transmitting the second screw tightening signals.

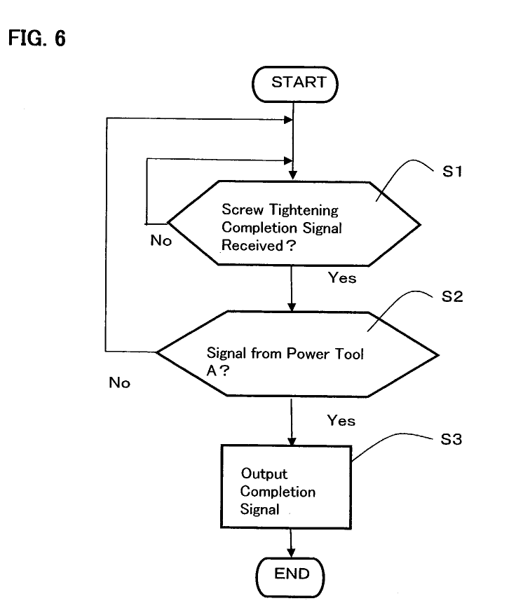

Work completion procedure in each of the receivers 155A, 155B and 155C is shown in FIG. 6 as a flow chart. Because the procedure performed in each of the receivers 155A, 155B and 155C is substantially identical, only the procedure performed in the receiver 155A (corresponded to the power tool 111A) is illustrated in FIG. 6 as a representative example. In step S1 of the procedure as shown in FIG. 6, it is determined as to whether the receiver 155A has received a screw tightening completion signal for any of the power tools 111A, 111B and 111C. Step S1 will be repeated until the screw tightening completion signal is received. When it is determined in step S1 that the receiver 155A has received the screw tightening completion signal, subsequently in step S2, it is determined as to whether the received signal is transmitted from the power tool 111A. This determination is made by reference to the tool identification information included within the data forming the screw tightening completion signals.

When it is determined in step S2 that the received signal is from the power tool 111A, subsequently in step S3, the receiver 155A outputs a signal of the screw tightening completion of the power tool 111A via the outputting section 156b (see FIG. 1).

Although it is not particularly illustrated in the drawings, when the screw tightening completion signal is outputted from the outputting section 156b, the work controller 153 as shown in FIG. 1 is operated such that a screw tightening completion counter which is associated with the power tool 111A is counted up. Then, the work controller 153 performs other controlling operations, such as updating the work management data in the indicator 157 (see FIG. 4).

While FIG. 6 shows the work completion procedure within the receiver 155A that is associated with the power tool 111A, the same procedure is also performed within the receivers 155B and 155C which are associated with the power tools 111B and 111C, respectively.

In the above-mentioned work control system 100, one of the receivers 155A, 155B and 155C may possibly receive, at the same time, two (or three) of the tightening completion signals of the respective power tools 111A, 111B 111C. For example, when the receiver 155A receives the screw tightening completion signals “10000010” for the power tool 111A and “01111101” for the power tool 111B at the same time, such signals interfere with each other. As the result, a confusion of the signals may take place and incorrect signal such as “11111111” (“#FFH” in hexadecimal notation) will be generated.

In such a case, the receiver 155A cannot identify the received signal (interfered signal) in the process routine as shown in FIG. 6. Therefore, in step S2, the receiver 155A determines that the received signal is not a screw tightening completion signal of the power tool 111A, so that the procedure will be returned to step S1. However, as mentioned above, the respective screw tightening completion signals of the power tools 111A, 111B and 111C are arranged to have transmission intervals different from each other. As the result, even if interference occurs in the first reception of screw tightening completion signals, the signals can be identified in the second reception of the screw tightening completion signals, because the second screw tightening completion signals are transmitted at the predetermined transmission intervals (of t1, t2 or t3 seconds) and received by the receiver 155A in the timings that vary among the power tools 111A, 111B and 111C.

Specifically, in this embodiment, screw tightening completion signals are designed to be transmitted several times from the plurality of power tools 111A, 111B and 111C at the transmission intervals that vary among the power tools 111A, 111B and 111C. Therefore, even if any of the receivers 155A, 155B and 155C receives screw tightening completion signals for the plurality of power tools at the same time and thus such signals interfere with each other, such receiver will receive the next screw tightening completion signals in the timings that vary among the power tools 111A, 111B and 111C. Thus, it is made possible to positively identify and ascertain the work progress for each of the power tools 111A, 111B and 111C.

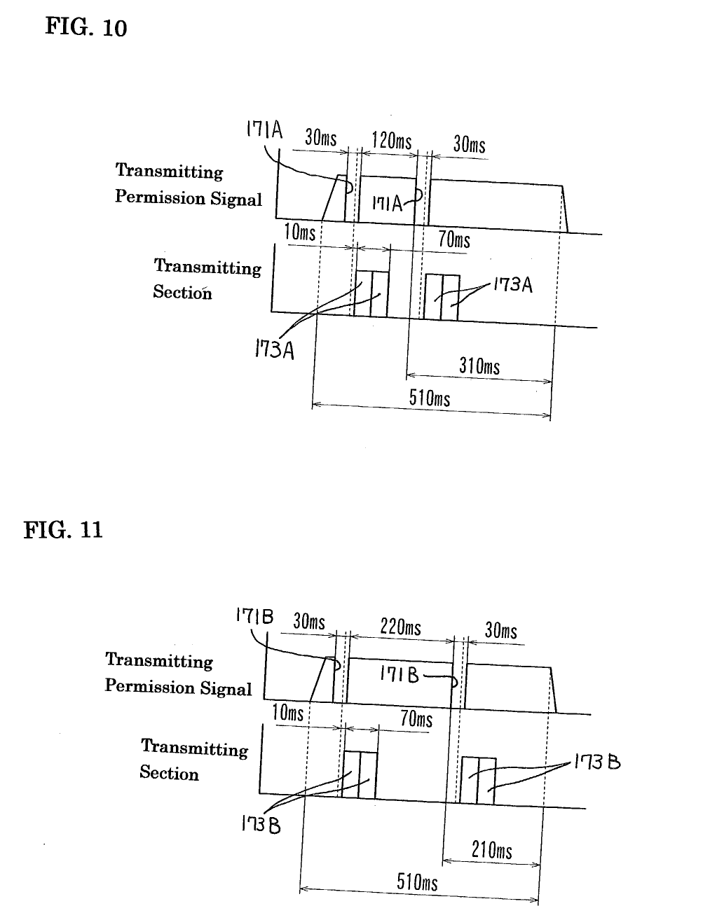

FIGS. 10, 11 and 12 show examples of screw tightening completion signals generated in the power tools 111A, 111B and 111C, respectively.

In FIG. 10, when the first transmitting permission signal 171A is outputted, two tightening completion signals 173A are outputted consecutively after a lapse of 30 milliseconds. Specifically, the tightening completion signal 173A is transmitted twice in a row after a lapse of 10 milliseconds of specified delay time following a lapse of 20 milliseconds of waiting time after the transmitting permission signal has been outputted. Further, the second transmitting permission signal is outputted 120 milliseconds after the first transmitting permission signal is outputted. Based upon the second transmitting permission signal, the second tightening completion signal is transmitted twice in a row. In this case, 10 milliseconds of delay time corresponds to the time required for preparation before the screw tightening completion signal is actually transmitted in step S7 when it is determined that the predetermined time interval has elapsed (when it is determined as “Yes”) in step S6 of the screw tightening completion signal transmitting process routine as shown in FIG. 5.

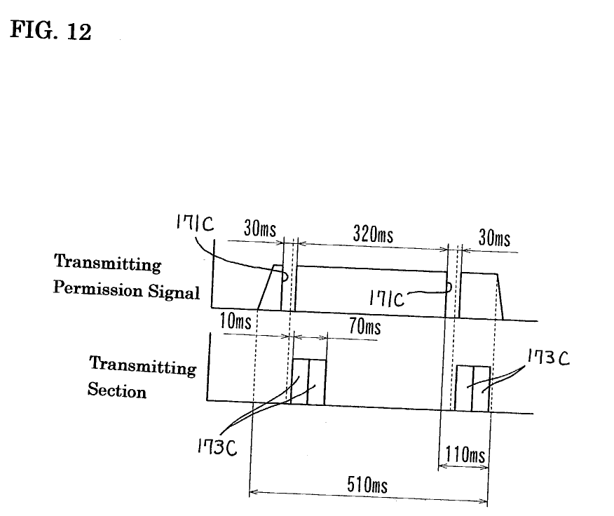

The similar process is also performed with respect to the screw tightening completion signals generated in the power tools 111B and 111C, which are shown in FIGS. 11 and 12, respectively. However, the power tool 111B has 220 milliseconds of a transmission interval between the first and the second tightening completion signals 173B as shown in FIG. 11. The power tool 111C has 320 milliseconds of a transmission interval between the first and the second tightening completion signals 173C as shown in FIG. 12. Therefore, even if, in the first transmission of screw tightening completion signals, screw tightening completion signals for the plurality of power tools are received at the same time and thus such signals interfere with each other, screw tightening completion signals of any of the power tools are transmitted at the second transmission in the timings that vary among the power tools. Thus, it is made possible to achieve positive work control without causing interference of the signals.

Signals other than a screw tightening completion signal may be utilized as a signal relating to the work progress. For example, when a wrench or impact wrench is used as a power tool, in addition to the tool identification information, information on the tightening torque may be utilized. Further, it may be designed such that the signal is transmitted three or more times.

Moreover, the respective transmission intervals t1, t2, t3 in the power tools 111A, 111B, 111C may be stored in the ROM 165 as a fixed value, or alternatively, they may be programmed in the CPU 161 at random based on random numbers. Even in such random setting, the provability of the transmission intervals of the power tools to be coincident with each other can be kept at quite low percentage. Therefore, practically, the possibility of interference can be minimized. Further, considering the provability of the randomly programmed transmission intervals of the power tools being coincident with each other, which can not be kept zero, it may preferably be arranged to transmit the tightening completion signals three or more times and by programming the transmission intervals at random. Thus, the risk of the coincident of the signals can be minimized.

We claim:

1. A work control system to utilize power tools, comprising:
a plurality of power tools and
a detecting device that receives signals in relation to work progress of the power tools transmitted from the respective power tools thereby detecting the work progress of each power tool, wherein each power tool transmits the signals several times and transmission intervals of the signals vary among the power tools.

2. The work control system as defined in claim 1, wherein each signal includes information at least to identify the power tools.

3. The work control system as defined in claim 1, wherein the work progress signals include information to identify the power tools and the work progress signals are transmitted several times at intervals that are set at values varying among the power tools so as to prevent the work progress signals from being detected by the detecting device at the same time.

4. The work control system as defined in claim 1, wherein the work progress signals include information to identify the power tools and the work progress signals are transmitted at several times at random intervals so as to prevent the work progress signals from being detected by the detecting device at the same time.

5. The work control system as defined in claim 4, wherein the work progress signals are transmitted at least three times at random intervals.

6. The work control system as defined in claim 1, wherein the work progress can be identified by the combination of the plurality of signals, the plurality of signals is transmitted at time intervals that are set at values varying among the power tools so as to prevent the signals from being detected by the detecting device at the same time.

7. The work control system as defined in claim 1, wherein each of the power tools performs same function.

8. The work control system as defined in claim 1, wherein at least one of the power tools performs function that is different from other power tools.

9. The work control system as defined in claim 1, wherein the work progress signal includes at least any one of the information of the completion of predetermined work, number of tightened screws and value of torque to tighten the screw.

10. A method of controlling work performed by utilizing power tools, comprising the steps of:
transmitting signals relating to work progress of the power tools from each of the power tools during the operation, wherein the work progress signals are transmitted from each of the power tools at several times and transmission intervals of the work progress signals vary among the power tools and
detecting the work progress of each of the power tools.

11. Method as defined in claim 10, wherein each signal includes information at least to identify the power tools.

12. Method as defined in claim 10, wherein the work progress signals include information to identify the power tools and the work progress signals are transmitted several times at intervals that are set at values varying among the power tools so as to prevent the work progress signals from being detected by the detecting device at the same time.

13. Method as defined in claim 10, wherein the work progress signals include information to identify the power tools are the work progress signals are transmitted several times at random intervals so as to prevent the work progress signals from being detected by the detecting device at the same time.

14. Method as defined in claim 13, wherein the work progress signals are transmitted at least three times at random intervals.

15. Method as defined in claim 10, wherein the work progress can be identified by the combination of the plurality of signals, the signals are transmitted at time intervals that are set at values varying among the power tools so as to prevent the signals from being detected by the detecting device at the same time.

16. A power tool designed to transmit signals several times in relation to work progress performed by the power tool, wherein the signals are transmitted at random intervals.

17. A work control system to utilize power tools, comprising:
a plurality of power tools and
means for detecting signals in relation to work progress of the power tools transmitted from the respective power tools, wherein each power tool transmits signals several times and transmission intervals of said signals vary among the power tools.

18. The work control system as defined in claim 17, wherein each signal includes information at least to identify the power tools.

19. The work control system as defined in claim 17, wherein the work progress signals include information to identify the power tools and the work progress signals are transmitted several times at intervals that are set at values varying among the power tools so as to prevent the work progress signals from being received at the same time by the detecting means.

20. The work control system as defined in claim 17, wherein the work progress signals include information to identify the power tools and the work progress signals are transmitted at several times at random intervals so as to prevent the work progress signals from being received at the same time by the detecting means.

21. The work control system as defined in claim 20, wherein the work progress signals are transmitted at least three times at random intervals.

22. The work control system as defined in claim 17, wherein the work progress can be identified by the combination of the plurality of signals, the plurality of signals is transmitted at time intervals that are set at values varying among the power tools so as to prevent the signals from being received at the same time by the detecting means.

23. The work control system as defined in claim 17, wherein each of the power tools performs same function.

24. The work control system as defined in claim 17, wherein at least one of the power tools performs function that is different from other power tools.

25. The work control system as defined in claim 17, wherein the work progress signal includes at least any one of the information of the completion of predetermined work, number of tightened screws and value of torque to tighten the screw.
